(19) United States
(12) Patent Application Publication
(10) Pub. No.: US 2019/0113153 A1
(43) Pub. Date: Apr. 18, 2019

(54) BRACKET FOR A TUBE OF AN ENGINE IN A SPACE-LIMITED COMPARTMENT

(71) Applicant: United Technologies Corporation, Farmington, CT (US)

(72) Inventors: Kristina L. Alexander, Port St. Lucie, FL (US); David G. Hastings, Port St. Lucie, FL (US)

(21) Appl. No.: 15/783,332

(22) Filed: Oct. 13, 2017

(51) Int. Cl. F16L 3/02; F02C 3/04

(52) U.S. Cl. CPC F16L 3/02; F02C 3/04; F05D 2240/35; F05D 2220/32; F05D 2260/31; F05D 2230/237; F05D 2260/30

(57) ABSTRACT

Aspects are directed to a bracket comprising: a first portion corresponding to a J-blade, a second portion integral with the first portion, the second portion corresponding to an L-bracket, and a third portion integral with the second portion, the third portion configured to rotate about a fold-line that coincides with an interface between the second portion and the third portion. Aspects are directed to a system comprising: a tube, a first housing that includes a first flange, a second housing that includes a second flange, the second flange abutting the first flange, and a bracket that includes a first portion corresponding to a J-blade that at least partially seats the tube, and a second portion integral with the first portion, the second portion corresponding to an L-bracket, and the second portion abutting the second flange.

### BACKGROUND

Engines, such as those which power aeronautical and industrial equipment, may employ a compressor to compress air that is drawn into the engine and a turbine to capture energy associated with the combustion of a fuel-air mixture. In some applications, physical space that is available for an engine may be limited. For example, in some applications an engine may be required to fit within a compartment that is on the order of 10-30 centimeters in dimension (e.g., diameter).

When physical space is limited (e.g., where physical clearances between engine hardware are small/less than a threshold), engine hardware that is available may represent a limiting factor in terms of the design and implementation of the engine. For example, the use of relatively small plumbing/tubing (e.g., on the order of 3 millimeters in diameter) may represent an additional constraint in terms of, e.g., mating/support hardware that is used in the engine; the mating/support hardware may be used to counteract vibratory conditions that may be imposed on the tubing.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a bracket comprising: a first portion corresponding to a J-blade, a second portion integral with the first portion, the second portion corresponding to an L-bracket, and a third portion integral with the second portion, the third portion configured to rotate about a fold-line that coincides with an interface between the second portion and the third portion. In some embodiments, the bracket is made of at least one of steel or nickel. In some embodiments, the first portion includes a sub-portion that has a radius of curvature within a range of 0.1 to 10 millimeters. In some embodiments, the second portion comprises: a first sub-portion that is integral with the first portion, a second sub-portion that is integral with the third portion, and a curved third sub-portion that spans the first sub-portion and the second sub-portion. In some embodiments, the first portion seats a tube, and where the second portion is coupled to a flange of a housing, and where the third portion is a washer tab that provides for anti-rotation with respect to a nut.

Aspects of the disclosure are directed to a system comprising: a tube, a first housing that includes a first flange, a second housing that includes a second flange, the second flange abutting the first flange, and a bracket that includes a first portion corresponding to a J-blade that at least partially seats the tube, and a second portion integral with the first portion, the second portion corresponding to an L-bracket, and the second portion abutting the second flange. In some embodiments, the system comprises a fastener that projects through the first flange, the second flange, and the second portion, and a nut disposed on the fastener. In some embodiments, the nut abuts the second portion to hold the first flange, the second flange, and the second portion in mated assembly. In some embodiments, the bracket includes a third portion integral with the second portion, the third portion configured to rotate about a fold-line that interfaces the second portion and the third portion. In some embodiments, the third portion is configured to provide for anti-rotation with respect to the nut. In some embodiments, the third portion includes a V-shaped segment that interfaces to a vertex of the nut. In some embodiments, the system comprises a fluid source configured to provide a fluid to the tube. In some embodiments, the fluid is air. In some embodiments, the fluid is a fuel. In some embodiments, the first housing is associated with a compressor section of an engine, and where the second housing is associated with a combustor section of the engine.

Aspects of the disclosure are directed to a turbojet engine comprising: a shaft, a compressor section disposed within a first housing, a combustor section disposed within a second housing, a turbine section configured to extract energy from an output of the combustor section to drive the compressor section via the shaft, a tube disposed proximate the second housing, and a bracket that includes a first portion corresponding to a i-blade that at least partially seats the tube, and a second portion integral with the first portion, the second portion corresponding to an L-bracket, and the second portion abutting a flange of the second housing. In some embodiments, the engine comprises a manifold coupled to the tube that supplies a fluid to the tube. In some embodiments, the engine comprises a fastener that projects through a flange of the first housing, the flange of the second housing, and the second portion, and a nut disposed on the fastener, the nut abutting the second portion to hold the flange of the first housing, the flange of the second housing, and the second portion in mated assembly. In some embodiments, the bracket includes a third portion integral with the second portion, the third portion arranged as a washer tab that limits a rotation of the nut when a V-shaped segment of the third portion interfaces with a vertex of the nut. In some embodiments, the tube is brazed to the first portion.

### BRIEF DESCRIPTION OF THE DRAWINGS

The present disclosure is illustrated by way of example and not limited in the accompanying figures in which like reference numerals indicate similar elements. The figures are not necessarily drawn to scale unless explicitly indicated otherwise.

FIG. 1 is a side cutaway illustration of an axial flow turbojet engine.

FIG. 1A is a side cutaway illustration of a centrifugal/radial flow turbojet engine.

FIG. 2 illustrates a system that incorporates a bracket for supporting a tube with respect to a housing in accordance with aspects of this disclosure.

FIG. 3 illustrates a fastener and a nut for holding flanges of housings and a portion of a bracket in mated assembly.

FIG. 4 illustrates a washer tab that interfaces with a nut in accordance with aspects of this disclosure.

FIG. 5 illustrates a profile of a J-blade in accordance with aspects of this disclosure.

FIG. 6 illustrates a profile of an L-bracket in accordance with aspects of this disclosure.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems and methods are described for providing a bracket for a tube of an engine. In some embodiments, a bracket may combine aspects/portions of one or more of a J-blade, an L-bracket, and one or more washer tabs. The J-blade portion may interface to and support a tube. The L-bracket portion may be attached to a housing flange via a fastener. In some embodiments, a washer tab may be used to provide for anti-rotation with respect to a nut coupled to the fastener.

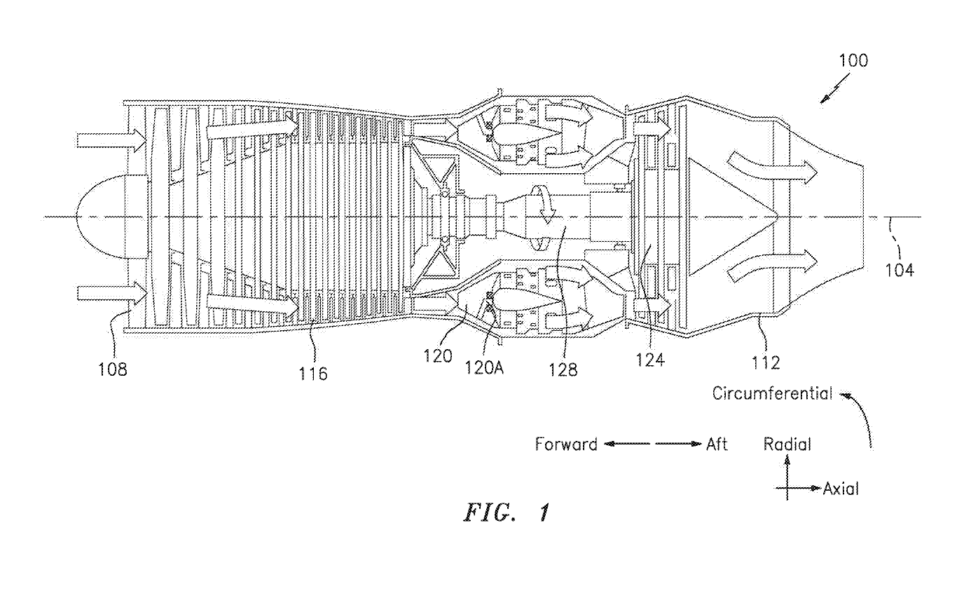

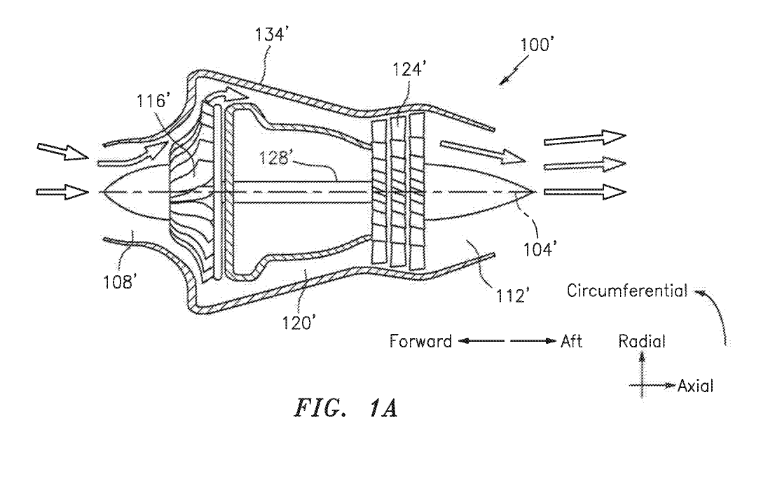

Aspects of the disclosure may be applied in connection with an engine. FIG. 1 is a side cutaway illustration of an axial flow turbojet engine 100. The engine 100 may extend along a longitudinal axial centerline 104 between an upstream/forward airflow inlet 108 and a downstream/aft airflow exhaust nozzle 112. The engine 100 may include a compressor section 116, a combustor section 120, and a turbine section 124.

During operation, air may enter the engine 100 through the inlet 108 where it may be compressed by the compressor section 116. The compressed air may be provided to the combustor section 120. In the combustor section 120, the compressed air may be mixed with fuel provided by one or more fuel nozzles 120a and ignited to power the engine 100. The output of the combustor section 120 may be provided to the turbine section 124. The turbine section 124 may extract energy from the output of the combustor section 120 to drive the compressor section 116 via a rotation of a shaft 128 that couples (e.g., mechanically couples) the compressor section 116 and the turbine section 124. The combusted fuel-air mixture may be exhausted via the nozzle 112.

FIG. 1A is a side cutaway illustration of centrifugal/radial flow turbojet engine 100′. The engine 100′ may include an inlet 108′, a compressor section 116′, a combustor section 120′, a turbine section 124′, and an exhaust nozzle 112′, The engine 100′ (and its associated sections/devices/components) may be similar to the engine 100. The engine 100′ may differ from the engine 100 in that the compressor section 116′ may direct the incoming airflow through the inlet 108′ in a circumferential direction and/or in a radial (outboard) direction (relative to the engine centerline/axis 104′). This airflow may be redirected by, e.g., the engine casing 134′ downstream of the compressor section 116′ so as to be more parallel to the axis 104′.

FIGS. 1 and 1A represents possible configurations for an engine. Aspects of the disclosure may be applied in connection with other environments, including additional configurations for engines. For example, aspects of the disclosure may be applied in connection with turbofan engines, turboprops, turboshafts, etc.

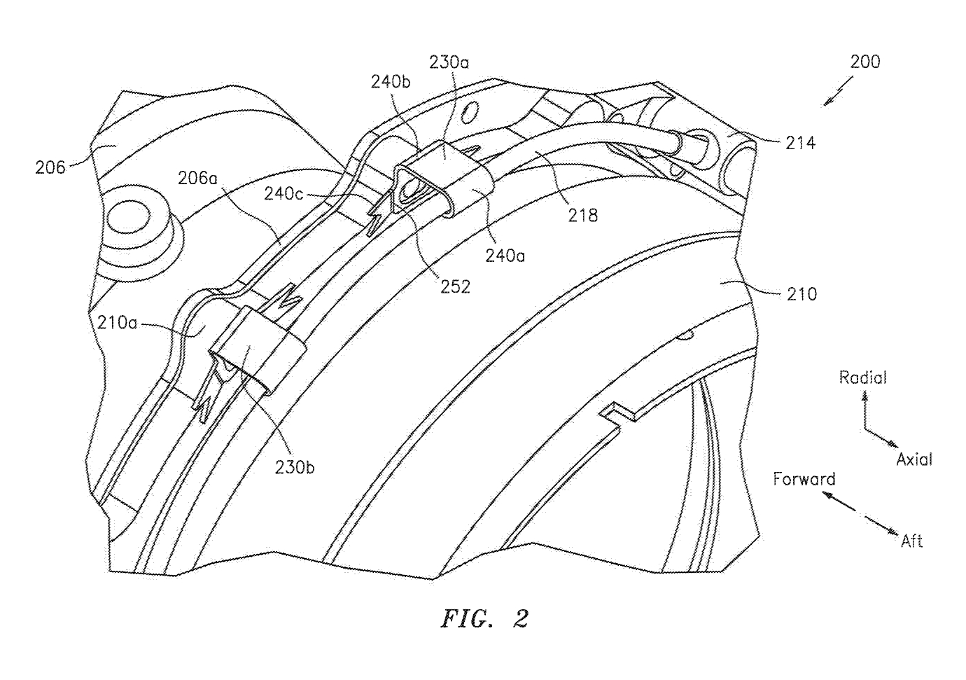

Referring to FIG. 2, a system 200 is shown. The system 200 may be incorporated as part of an engine, such as for example the engine 100 of FIG. 1, the engine 100′ of FIG. 1A, etc.

The system 200 may include one or more components/devices. For example, the system 200 may include one or more of a first housing/case 206, a second housing/case 210, a fluid source/manifold 214, a tube 218, and one or more tube clamp brackets (e.g., brackets 230a and 230b). The components of the system 200 may be made of one or more materials, such as steel or nickel.

The first housing 206 and the second housing 210 may be associated with one or more sections of an engine. For example, the first housing 206 may be associated with/contain an inlet/compressor section of an engine and the second housing 210 may be associated with/contain a combustor section of an engine. The housings 206 and 210 may include respective flanges 206a and 210a that may be used to couple (e.g., fasten) the housings 206 and 210 to one another as described below.

The fluid source 214 may be used to convey a fluid with respect to one or more sections of the engine. For example, the fluid source 214 may provide fuel to the combustor section (e.g., a fuel nozzle of the combustor section). In some embodiments, the fluid may include a hydrocarbon gas mixture, such as for example natural gas. In some embodiments, the fluid source 214 may provide other forms/types of fluid, such as for example air. In some embodiments, the fluid may be used for purposes of cooling.

The fluid provided by the fluid source 214 may be conveyed/distributed around a perimeter (e.g., a circumference) of, e.g., the second housing 210 via the tube 218. The tube 218 may be relatively small; e.g., the tube 218 may have a diameter within a range of 1 to 5 (e.g., 2 to 4) millimeters.

The tube 218 may be supported by the brackets 230a and 230b as described further below. While two brackets (e.g., brackets 230a and 230b) are shown in FIG. 2, any number of brackets may be used. The count and/or location of the brackets may be based on a vibration or structural analysis of the engine in terms of, e.g., the operating envelope/parameters of the engine. The brackets 230a and 230b may be coupled (e.g., attached) to the housing flange 210a as described further below.

Each of the brackets (e.g., the bracket 230a) may include one or more of a first portion 240a, a second portion 240b, and a third portion 240c. The portions 240a-240c may be integral with one another. For example, the bracket 230a (inclusive of the portions 240a-240c) may be manufactured/fabricated as a single unit/piece of sheet metal that may be bent into the form/shape shown in FIG. 2.

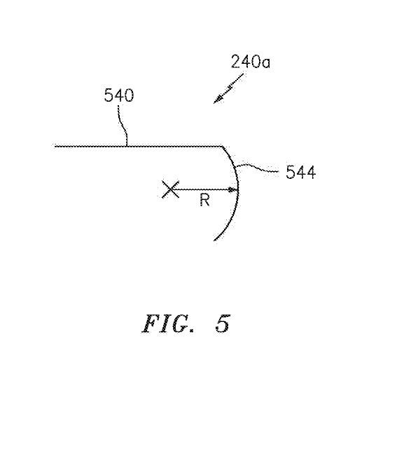

Referring to FIGS. 2 and 5, the first portion 240a may be substantially shaped as the letter ‘J’ and may be referred to as a J-blade. For example, the first portion 240a may include a first sub-portion 540 and a second sub-portion 544 that collectively are shaped as the letter ‘J’. A (radius R of) curvature associated with the second sub-portion 544 may be selected to support/seat the tube 218; tier example, a size/value of the radius R may be based on a size (e.g., a diameter) of the tube 218. In some embodiments, the radius R may be equal to a value within a range of 0.1 millimeters to 10 millimeters. The first sub-portion 540 may be integral with the second portion 240b. In some embodiments, the tube 218 and the first portion 240a (e.g., the second sub-portion 544) may be joined to one another via a braze.

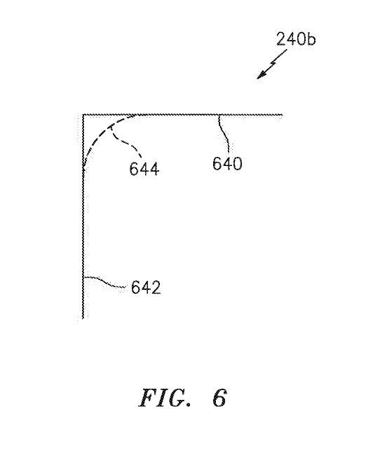

Referring to FIGS. 2 and 6, the second portion 240b may be substantially shaped as the letter ‘L’ and may be referred to as an L-bracket. For example, the second portion 240b may include a first sub-portion 640 and a second sub-portion 642 that collectively are shaped as the letter ‘L’. The first sub-portion 640 may be integral with the first portion 240a (e.g., the first sub-portion 540: see FIG. 5). The second sub-portion 642 may be integral with the third portion 240c.

The first sub-portion 640 and the second sub-portion 642 may be joined together at, e.g., a right angle as shown in FIG. 6. Alternatively, the first sub-portion 640 and the second sub-portion 642 may be joined to one another/bridged by a curved, third sub-portion 644; the third sub-portion 644 may span the first sub-portion 640 and the second sub-portion 642. The use of the third sub-portion 644 may help to avoid imposing stress at the interface between the first sub-portion 640 and the second sub-portion 642. The curvature associated with the third sub-portion 644 may be based on one or more analyses, such as for example a stress analysis or a finite-element analysis. Even with the third sub-portion 644, the second portion 240b may be referred to as an L-bracket.

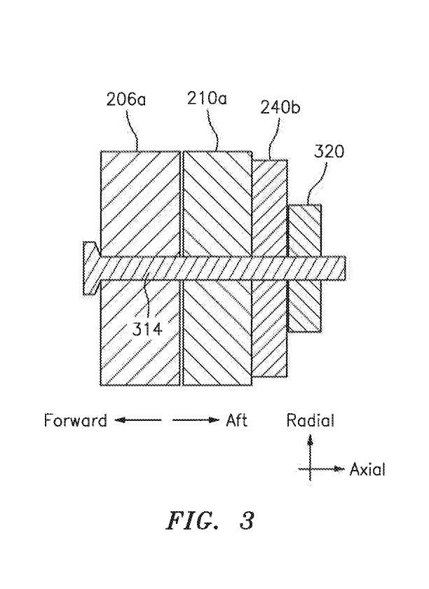

Referring to FIGS. 2-3 and 6, the second portion 240b (e.g., the second sub-portion 642) may be coupled (e.g., attached) to the housing flange 210a via a fastener 314. More specifically, and as shown in FIG. 3, the fastener 314 may project through (a hole in) the flange 206a, (a hole in) the flange 210a, and (a hole in) the second portion 240b (e.g., the second sub-portion 642). A nut 320 may be installed on the fastener 314; the nut 320 may abut an end/surface of, e.g., the second portion 240b to hold the flange 206a, the flange 210a and the second portion 240b in mated assembly.

As described above, clearances between the various components of the engine (e.g., the components of the system 200 of FIG. 2) may be small in some embodiments. To provide some perspective/context, a(n axial) distance/clearance between the flange 210a and the tube 218 may be on the order of approximately 5 to 10 millimeters. Suffice it to say, regardless of the actual values associated with the clearances in a given embodiment, installation of the fastener 314 and the nut 320 may prove challenging where space is limited. For example, tool (e.g., wrench) access to the nut 320 may be limited.

In order to accommodate the installation of the fastener 314 and the nut 320, the third portion 240c may be included with the bracket 230a (potentially in lieu of using a conventional washer). The third portion 240c may correspond to a washer tab that may project from the second portion 240b. The washer tab 240c is shown in FIG. 2 prior to the installation of the fastener 314 and nut 320. After the fastener 314 and nut 320 are installed (see, e.g., FIG. 3), the washer tab 240c may be bent/rotated about an axis/fold-line 252 to interface/contact the nut 320 (where the fold-line 252 corresponds to the interface between the second portion 240b and the third portion/washer tab 240c).

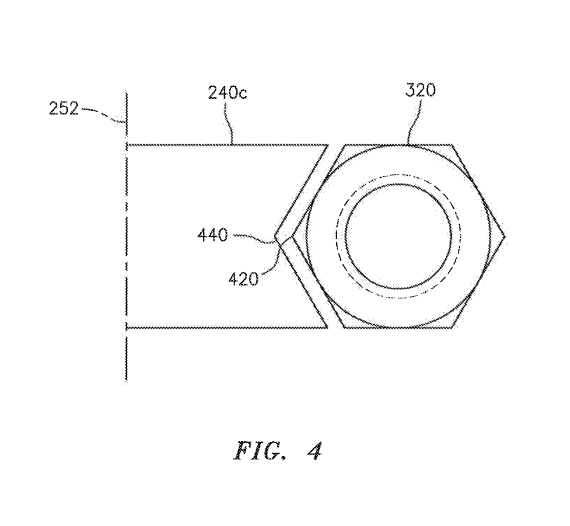

The washer tab 240c may include one or more anti-rotation features that may limit (e.g., prevent) a rotation of the nut 320. For example, and as more clearly shown in FIG. 4, the washer tab 240c may include a V-shaped segment 440 that may interface to a vertex 420 of the nut 320 to provide the anti-rotation.

As described herein, a bracket may be used to seat/support a tube of an engine. Features/portions of the bracket may be selected/arranged to accommodate engine hardware. For example, integral portions of a bracket may accommodate a placement and installation of the bracket within a relatively confined/limited physical space/compartment.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

What is claimed is:

1. A bracket comprising:
a first portion corresponding to a J-blade;
a second portion integral with the first portion, the second portion corresponding to an L-bracket; and
a third portion integral with the second portion, the third portion configured to rotate about a that coincides with an interface between the second portion and the third portion.

2. The bracket of claim 1, wherein the bracket is made of at least one of steel or nickel.

3. The bracket of claim 1, wherein the first portion includes a sub-portion that has a radius of curvature within a range of 0.1 to 10 millimeters.

4. The bracket of claim 1, wherein the second portion comprises:
a first sub-portion that is integral with the first portion;
a second sub-portion that is integral with the third portion; and
a curved third sub-portion that spans the first sub-portion and the second sub-portion.

5. The bracket of claim 1, wherein the first portion seats a tube, and wherein the second portion is coupled to a flange of a housing, and wherein the third portion is a washer tab that provides for anti-rotation with respect to a nut.

6. A system comprising:
a tube;
a first housing that includes a first flange;
a second housing that includes a second flange, the second flange abutting the first flange; and
a bracket that includes
a first portion corresponding to a J-blade that at least partially seats the tube; and
a second portion integral with the first portion, the second portion corresponding to an L-bracket, and the second portion abutting the second flange.

7. The system of claim 6, further comprising:
a fastener that projects through the first flange, the second flange, and the second portion; and
a nut disposed on the fastener.

8. The system of claim 7, wherein the nut abuts the second portion to hold the first flange, the second flange, and the second portion in mated assembly.

9. The system of claim 7, wherein the bracket includes a third portion integral with the second portion, the third portion configured to rotate about a fold-line that interfaces the second portion and the third portion.

10. The system of claim 9, wherein the third portion is configured to provide for anti-rotation with respect to the nut.

11. The system of claim 10, wherein the third portion includes a V-shaped segment that interfaces to a vertex of the nut.

12. The system of claim 6, further comprising:
a fluid source configured to provide a fluid to the tube.

13. The system of claim 12, wherein the fluid is air.

14. The system of claim 12, wherein the fluid is a fuel.

15. The system of claim 6, wherein the first housing is associated with a compressor section of an engine, and wherein the second housing is associated with a combustor section of the engine.

16. A turbojet engine comprising:
a shaft;
a compressor section disposed within a first housing;
a combustor section disposed within a second housing;
a turbine section configured to extract energy from an output of the combustor section to drive the compressor section via the shaft;
a tube disposed proximate the second housing; and
a bracket that includes
a first portion corresponding to a J-blade that at least partially seats the tube; and
a second portion integral with the first portion, the second portion corresponding to an L-bracket, and the second portion abutting a flange of the second housing.

17. The engine of claim 16, further comprising:
a manifold coupled to the tube that supplies a fluid to the tube.

18. The turbojet engine of claim 16, further comprising:
a fastener that projects through a flange of the first housing, the flange of the second housing, and the second portion; and
a nut disposed on the fastener, the nut abutting the second portion to hold the flange of the first housing, the flange of the second housing, and the second portion in mated assembly.

19. The turbojet engine of claim 18, wherein the bracket includes a third portion integral with the second portion, the third portion arranged as a washer tab that limits a rotation of the nut when a V-shaped segment of the third portion interfaces with a vertex of the nut.

20. The turbojet engine of claim 16, wherein the tube is brazed to the first portion.
